(19) United States
(12) Patent Application Publication
(10) Pub. No.: US 2018/0328229 A1
(43) Pub. Date: Nov. 15, 2018

(54) EXHAUST DIFFUSER

(71) Applicant: KAWASAKI JUKOGYO KABUSHIKI KAISHA, Hyogo (JP)

(72) Inventors: Kazuhiko TANIMURA, Akashi-shi, Hyogo (JP); Yoshihiro YAMASAKI, Kobe-shi, Hyogo (JP); Koji TERAUCHI, Kobe-shi, Hyogo (JP); Naoto SAKAI, Osaka-shi, Osaka (JP)

(73) Assignee: KAWASAKI JUKOGYO KABUSHIKI KAISHA, Hyogo (JP)

(21) Appl. No.: 15/580,923

(22) PCT Filed: Jun. 9, 2016
(86) PCT No.: PCT/JP2016/002794

§ 371 Date: Dec. 8, 2017

(30) Foreign Application Priority Data
Jun. 9, 2015 (JP) 2015-116352

(51) Int. Cl. F01D 25/30; F01D 25/16; F01D 25/24

(52) U.S. Cl. CPC F01D 25/30; F01D 25/162; F05D 2220/32; F05D 2230/232; F01D 25/24

(57) ABSTRACT

An exhaust diffuser includes: a plurality of struts, each of which penetrates an internal cylinder and an external cylinder and couples a bearing support and a structural body together, the bearing support disposed inside the internal cylinder, the structural body disposed outside the external cylinder, each strut inclined rearward from the bearing support toward the structural body; and a plurality of strut covers that surround the plurality of struts, respectively, between the internal cylinder and the external cylinder. The external cylinder includes a tapered first stepped portion that expands a diameter of the external cylinder and that overlaps leading edges of the plurality of strut covers in an axial direction of the external cylinder. The internal cylinder includes a tapered second stepped portion that expands a diameter of the internal cylinder and that overlaps trailing edges of the plurality of strut covers in an axial direction of the internal cylinder.

### TECHNICAL FIELD

The present invention relates to an exhaust diffuser.

### BACKGROUND ART

Conventionally, an exhaust diffuser that converts the dynamic pressure of exhaust gas from a turbine into static pressure is disposed downstream of the turbine. For example, Patent Literature 1 discloses an exhaust diffuser incorporated in a gas turbine engine.

The exhaust diffuser disclosed in Patent Literature 1 includes an internal cylinder and an external cylinder, each of which has a straight sectional shape from its front end to its rear end. Between the internal cylinder and the external cylinder, an exhaust passage expanding from front to rear is formed. Each of the internal cylinder and the external cylinder is manufactured by sheet metal working, and has a relatively small thickness.

The exhaust diffuser including the thin internal and external cylinders as above is difficult to handle as a strength member. For this reason, in the case of the exhaust diffuser disclosed in Patent Literature 1, a diffuser casing (a structural body) is disposed as a strength member outside the external cylinder. Meanwhile, a bearing support that supports a rotor via a bearing is disposed inside the internal cylinder. The bearing support and the structural body are coupled together by a plurality of struts that penetrate the internal cylinder and the external cylinder.

In the exhaust diffuser including these struts, the struts are surrounded by respective strut covers between the internal cylinder and the external cylinder in order to prevent the struts from being directly heated by the exhaust gas.

Since the strut covers are disposed between the internal cylinder and the external cylinder, in a region where such strut covers are present, the cross-sectional area of the exhaust passage is reduced by the cross-sectional areas of the respective strut covers. The “cross-sectional area of the exhaust passage” means the area of the smallest possible cross section of the exhaust passage. (Such a cross section is, when a sphere is placed in contact with the internal cylinder and the external cylinder in the exhaust passage, obtained along a line connecting between contact points at which the sphere is in contact with the internal cylinder and the external cylinder.) In particular, the cross-sectional area of the exhaust passage suddenly changes near the leading edges and the trailing edges of the strut covers. For the purpose of reducing such sudden changes in the cross-sectional area of the exhaust passage due to the strut covers, for example, Patent Literature 2 discloses forming, in each of the internal cylinder and the external cylinder, the same number of local recesses as the number of strut covers only at portions to which the strut covers are joined.

### CITATION LIST

### Patent Literature

PTL 1: Japanese Laid-Open Patent Application Publication No. 2011-127447

PTL 2: Japanese Laid-Open Patent Application Publication No. 2013-234678

### SUMMARY OF INVENTION

### Technical Problem

However, in a case where the internal cylinder and the external cylinder are manufactured by sheet metal working, it is difficult to form such a plurality of local recesses as in Patent Literature 2.

In view of the above, an object of the present invention is to provide an exhaust diffuser capable of reducing sudden changes in the cross-sectional area of the exhaust passage due to the strut covers, the sudden changes occurring near the leading edges and the trailing edges of the strut covers, the exhaust diffuser allowing the internal cylinder and the external cylinder to be readily manufactured by sheet metal working.

### Solution to Problem

In order to solve the above-described problems, an exhaust diffuser according to one aspect of the present invention includes: an internal cylinder; an external cylinder that forms an exhaust passage between the internal cylinder and the external cylinder, the exhaust passage expanding from front to rear; a plurality of struts, each of which penetrates the internal cylinder and the external cylinder and couples a bearing support and a structural body together, the bearing support being disposed inside the internal cylinder, the structural body being disposed outside the external cylinder, each strut being inclined rearward from the bearing support toward the structural body; and a plurality of strut covers that surround the plurality of struts, respectively, between the internal cylinder and the external cylinder. The external cylinder includes a tapered first stepped portion that expands a diameter of the external cylinder and that is positioned such that the first stepped portion overlaps leading edges of the plurality of strut covers in an axial direction of the external cylinder. The internal cylinder includes a tapered second stepped portion that expands a diameter of the internal cylinder and that is positioned such that the second stepped portion overlaps trailing edges of the plurality of strut covers in an axial direction of the internal cylinder.

The term “front” or “forward” herein refers to one side of the exhaust diffuser in its axial direction (the upstream side of a flow of exhaust gas), and the term “rear” or “rearward” herein refers to the other side of the exhaust diffuser in its axial direction (the downstream side of the flow of exhaust gas).

According to the above configuration, in the section from the first stepped portion of the external cylinder to the second stepped portion of the internal cylinder, the distance from the internal cylinder to the external cylinder is partly increased. This makes it possible to reduce sudden changes in the cross-sectional area of the exhaust passage due to the strut covers, the sudden changes occurring near the leading edges and the trailing edges of the strut covers. In addition, since it is unnecessary to form recesses in each of the internal cylinder and the external cylinder, the internal cylinder and the external cylinder can be readily manufactured by sheet metal working.

Moreover, in the above-described configuration, since each strut is inclined, each strut cover is also inclined rearward from the internal cylinder toward the external cylinder. Accordingly, the first stepped portion of the external cylinder is inclined in a manner similar to the leading edge of each strut cover, and the second stepped portion of the internal cylinder is inclined in a manner similar to the trailing edge of each strut cover. This makes it possible to smoothly and continuously change the cross-sectional area of the exhaust passage.

A rear end of the first stepped portion may coincide with upstream ends of the strut covers on the external cylinder, and a front end of the second stepped portion may coincide with downstream ends of the strut covers on the internal cylinder. This configuration makes it possible to readily weld each strut cover to the internal cylinder and the external cylinder.

An exhaust diffuser according to another aspect of the present invention includes: an internal cylinder; an external cylinder that forms an exhaust passage between the internal cylinder and the external cylinder, the exhaust passage expanding from front to rear; a plurality of struts, each of which penetrates the internal cylinder and the external cylinder and couples a bearing support and a structural body together, the bearing support being disposed inside the internal cylinder, the structural body being disposed outside the external cylinder, each strut being inclined forward from the bearing support toward the structural body; and a plurality of strut covers that surround the plurality of struts, respectively, between the internal cylinder and the external cylinder. The internal cylinder includes a tapered first stepped portion that reduces a diameter of the internal cylinder and that is positioned such that the first stepped portion overlaps leading edges of the plurality of strut covers in an axial direction of the internal cylinder. The external cylinder includes a tapered second stepped portion that reduces a diameter of the external cylinder and that is positioned such that the second stepped portion overlaps trailing edges of the plurality of strut covers in an axial direction of the external cylinder.

According to the above configuration, in the section from the first stepped portion of the internal cylinder to the second stepped portion of the external cylinder, the distance from the internal cylinder to the external cylinder is partly increased. This makes it possible to reduce sudden changes in the cross-sectional area of the exhaust passage due to the strut covers, the sudden changes occurring near the leading edges and the trailing edges of the strut covers. In addition, since it is unnecessary to form recesses in each of the internal cylinder and the external cylinder, the internal cylinder and the external cylinder can be readily manufactured by sheet metal working.

Moreover, in the above-described configuration, since each strut is inclined, each strut cover is also inclined forward from the internal cylinder toward the external cylinder. Accordingly, the first stepped portion of the internal cylinder is inclined in a manner similar to the leading edge of each strut cover, and the second stepped portion of the external cylinder is inclined in a manner similar to the trailing edge of each strut cover. This makes it possible to smoothly and continuously change the cross-sectional area of the exhaust passage.

In the exhaust diffuser according to the above other aspect, a rear end of the first stepped portion may coincide with upstream ends of the strut covers on the internal cylinder, and a front end of the second stepped portion may coincide with downstream ends of the strut covers on the external cylinder. This configuration makes it possible to readily weld each strut cover to the internal cylinder and the external cylinder.

### Advantageous Effects of Invention

The present invention makes it possible to reduce sudden changes in the cross-sectional area of the exhaust passage due to the strut covers, the sudden changes occurring near the leading edges and the trailing edges of the strut covers, and allows the internal cylinder and the external cylinder to be readily manufactured by sheet metal working.

### BRIEF DESCRIPTION OF DRAWINGS

FIG. 1 is a side view of a gas turbine engine in which an exhaust diffuser according to Embodiment 1 of the present invention is incorporated, showing a half of the gas turbine engine as a sectional view.

FIG. 2 is an enlarged view of an essential part of FIG. 1.

FIG. 3 is a sectional view taken along line of FIG. 2.

FIG. 4 is a sectional view of a part of an exhaust diffuser according to a first variation.

FIG. 5 is a sectional view of a part of an exhaust diffuser according to a second variation.

FIG. 6 is a sectional view showing a part of an exhaust diffuser according to Embodiment 2 of the present invention.

### DESCRIPTION OF EMBODIMENTS

### Embodiment 1

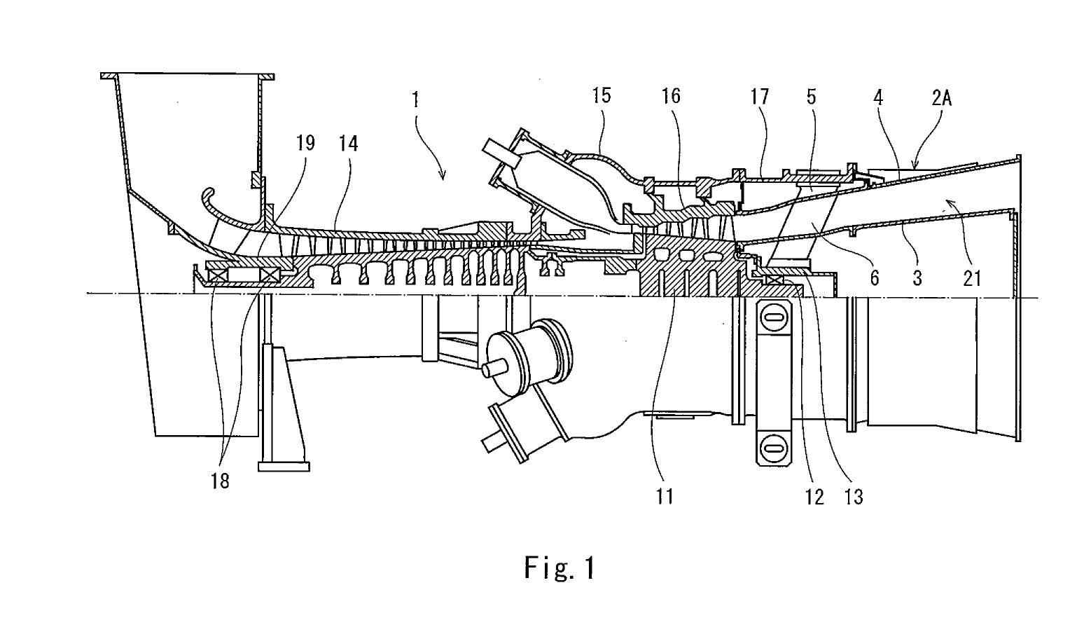

FIG. 1 shows a gas turbine engine 1, in which an exhaust diffuser 2A according to Embodiment 1 of the present invention is incorporated. Hereinafter, one side of the exhaust diffuser 2A in its axial direction (the upstream side of a flow of exhaust gas) is referred to as front or forward, and the other side of the exhaust diffuser 2A in its axial direction (the downstream side of the flow of exhaust gas) is referred to as rear or rearward.

The gas turbine engine 1 includes a compressor casing 14, a main housing 15, a turbine casing 16, and a diffuser casing 17 (corresponding to a structural body of the present invention). The turbine casing 16 is disposed in the main housing 15, and the diffuser casing 17 is coupled to the main housing 15.

A rotor 11 is disposed in the compressor casing 14 and the turbine casing 16, such that the rotor 11 penetrates these casings. The front end of the rotor 11 is supported by a bearing support 19 via bearings 18, and the rear end of the rotor 11 is supported by a bearing support 13 via a bearing 12.

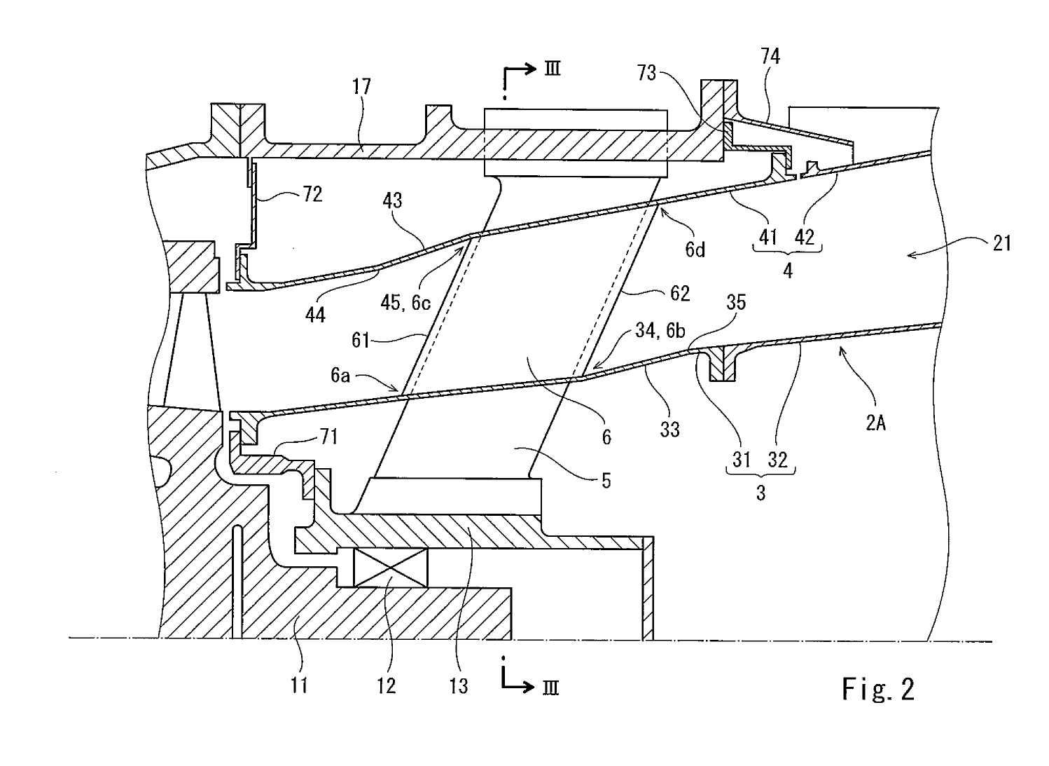

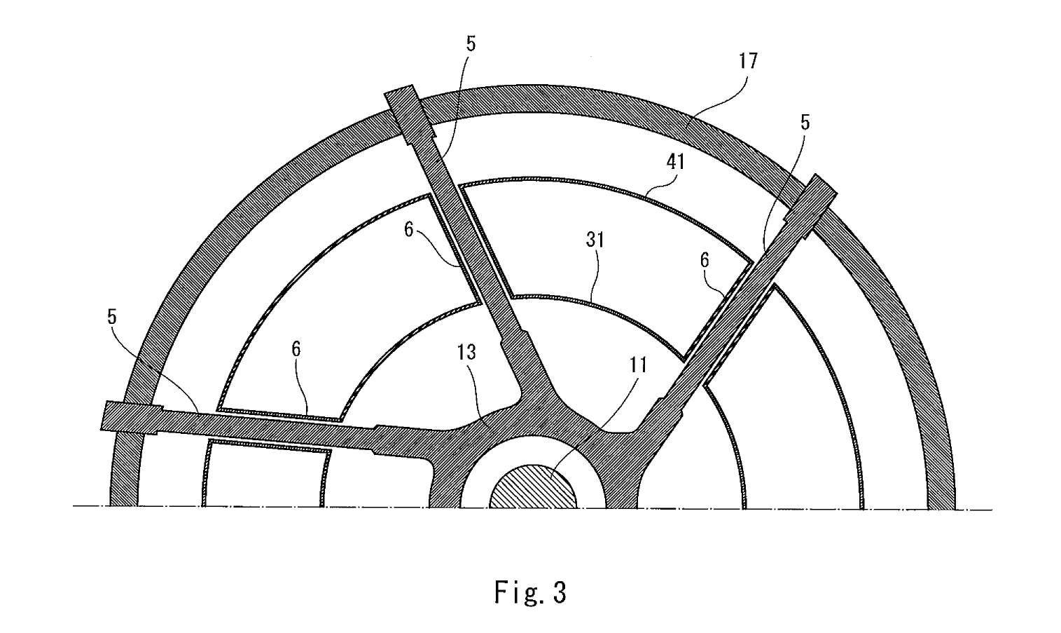

As shown in FIG. 2 and FIG. 3, the exhaust diffuser 2A includes an internal cylinder 3, an external cylinder 4, and a plurality of struts 5. Between the internal cylinder 3 and the external cylinder 4, an exhaust passage 21 expanding from front to rear is formed. In the present embodiment, both the internal cylinder 3 and the external cylinder 4 flare from front to rear. The aforementioned bearing support 13 is disposed inside the internal cylinder 3, and the aforementioned diffuser casing 17 is disposed outside the external cylinder 4.

In the present embodiment, the internal cylinder 3 is divided into a front piece 31 and a rear piece 32, and the external cylinder 4 is divided into a front piece 41 and a rear piece 42. However, each of the internal cylinder 3 and the external cylinder 4 may be formed as a single member.

The front end of the front piece 31 of the internal cylinder 3 is coupled to the bearing support 13 via a bracket 71. The rear end of the front piece 31 is coupled to the front end of the rear piece 32.

The front end of the front piece 41 of the external cylinder 4 is fixed to the diffuser casing 17 via a bracket 72, and the rear end of the front piece 41 is fixed to the diffuser casing 17 via a bracket 73. A bracket 74 is joined to the rear piece 42 of the external cylinder 4, for example, by welding, and the bracket 74 is fixed to the diffuser casing 17.

Each strut 5 penetrates the front piece 31 of the internal cylinder 3 and the front piece 41 of the external cylinder 4, and couples the bearing support 13 and the diffuser casing 17 together. Each strut 5 is inclined rearward from the bearing support 13 toward the diffuser casing 17. Each strut 5 is plate-shaped and flat in the flowing direction of the exhaust gas.

In the present embodiment, all the struts 5 are disposed on the same circumference, such that they fully overlap each other as seen in the circumferential direction. However, as an alternative, the struts 5 may be disposed in a staggered manner, such that adjoining struts 5 partly overlap each other as seen in the circumferential direction.

All the struts 5 are surrounded by a plurality of strut covers 6, respectively, between the internal cylinder 3 and the external cylinder 4. Each strut cover 6 has a sectional shape that is slightly larger than the sectional shape of the corresponding strut 5, and extends parallel to the strut 5. In other words, each strut cover 6 is inclined rearward from the internal cylinder 3 toward the external cylinder 4. Each strut cover 6 is joined to the front piece 31 of the internal cylinder 3 and the front piece 41 of the external cylinder 4, for example, by welding.

The external cylinder 4 includes a tapered first stepped portion 43, which is positioned such that the first stepped portion 43 overlaps a leading edge 61 of each strut cover 6 in the axial direction of the external cylinder 4. The first stepped portion 43 expands the diameter of the external cylinder 4 over the entire circumference, such that reduction in the cross-sectional area of the exhaust passage 21 due to the strut covers 6, the reduction occurring from the upstream side to the downstream side of the leading edges 61 of the strut covers 6, is offset (but not necessarily reduced to zero).

In the present embodiment, the inner peripheral surface of the external cylinder 4 has a straight sectional shape at the front of the first stepped portion 43, at the first stepped portion 43, and at the rear of the first stepped portion 43. Thus, the shape of the external cylinder 4 is simple. The sectional shape of the inner peripheral surface of the external cylinder 4 is described hereinafter in more detail. The inclination angle of the portion at the front of the first stepped portion 43 (i.e., the angle relative to the axial direction of the exhaust diffuser 2A) is equal to the inclination angle of the portion at the rear of the first stepped portion 43, and the inclination angle of the first stepped portion 43 is greater than each of the inclination angles of the portions at the front and rear of the first stepped portion 43. It should be noted that the tapered first stepped portion 43 may be curved.

Meanwhile, the internal cylinder 3 includes a tapered second stepped portion 33, which is positioned such that the second stepped portion 33 overlaps a trailing edge 62 of each strut cover 6 in the axial direction of the internal cylinder 3. The second stepped portion 33 expands the diameter of the internal cylinder 3 over the entire circumference, such that increase in the cross-sectional area of the exhaust passage 21 due to the strut covers 6, the increase occurring from the upstream side to the downstream side of the trailing edges 62 of the strut covers 6, is offset (but not necessarily reduced to zero).

In the present embodiment, the outer peripheral surface of the internal cylinder 3 has a straight sectional shape at the front of the second stepped portion 33, at the second stepped portion 33, and at the rear of the second stepped portion 33. Thus, the shape of the internal cylinder 3 is simple. The sectional shape of the inner peripheral surface of the internal cylinder 3 is described hereinafter in more detail. The inclination angle of the portion at the front of the second stepped portion 33 (i.e., the angle relative to the axial direction of the exhaust diffuser 2A) is equal to the inclination angle of the portion at the rear of the second stepped portion 33, and the inclination angle of the second stepped portion 33 is greater than each of the inclination angles of the portions at the front and rear of the second stepped portion 33. It should be noted that the tapered second stepped portion 33 may be curved.

In the present embodiment, a front end 44 of the first stepped portion 43 is positioned forward of an upstream end 6a of each strut cover 6 on the internal cylinder 3 (i.e., forward of the inner end of the leading edge 61), and a rear end 35 of the second stepped portion 33 is positioned rearward of a downstream end 6d of each strut cover 6 on the external cylinder 4 (i.e., rearward of the outer end of the trailing edge 62). A rear end 45 of the first stepped portion 43 coincides with an upstream end 6c of each strut cover 6 on the external cylinder 4 (i.e., coincides with the outer end of the leading edge 61), and a front end 34 of the second stepped portion 33 coincides with a downstream end 6b of each strut cover 6 on the internal cylinder 3 (i.e., coincides with the inner end of the trailing edge 62). This configuration makes it possible to readily weld each strut cover 6 to the internal cylinder 3 and the external cylinder 4. It should be noted that the rear end 45 of the first stepped portion 43 may be positioned forward of the upstream end 6c of each strut cover 6 on the external cylinder 4.

As described above, in the exhaust diffuser 2A of the present embodiment, in the section from the first stepped portion 43 of the external cylinder 4 to the second stepped portion 33 of the internal cylinder 3, the distance from the internal cylinder 3 to the external cylinder 4 is partly increased. This makes it possible to reduce sudden changes in the cross-sectional area of the exhaust passage 21 due to the strut covers 6, the sudden changes occurring near the leading edges 61 and the trailing edges 62 of the strut covers 6. In addition, since it is unnecessary to form recesses in each of the internal cylinder 3 and the external cylinder 4, the internal cylinder 3 and the external cylinder 4 can be readily manufactured by sheet metal working.

Further, in the present embodiment, each strut cover 6 is inclined rearward from the internal cylinder 3 toward the external cylinder 4. Accordingly, the first stepped portion 43 of the external cylinder 4 is inclined in a manner similar to the leading edge 61 of each strut cover 6, and the second stepped portion 33 of the internal cylinder 3 is inclined in a manner similar to the trailing edge 62 of each strut cover 6. This makes it possible to smoothly and continuously change the cross-sectional area of the exhaust passage 21.

Moreover, in the present embodiment, since the front end 44 of the first stepped portion 43 is positioned forward of the upstream end 6a of each strut cover 6 on the internal cylinder 3, a detouring flow along the leading edge 61 of each strut cover 6 can be formed even near the upstream end 6a of each strut cover 6 on the internal cylinder 3. Furthermore, since the rear end 35 of the second stepped portion 33 is positioned rearward of the downstream end 6d of each strut cover 6 on the external cylinder 4, flow separation of the exhaust gas can be suppressed even near the downstream end 6d of each strut cover 6 on the external cylinder 4.

### Variations

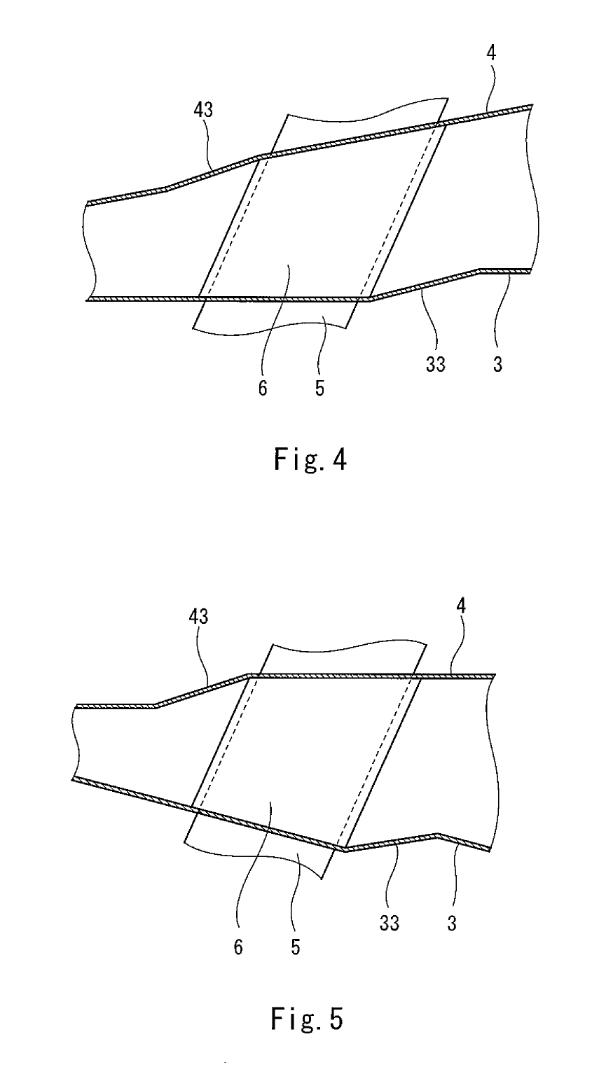

In the present embodiment, both the internal cylinder 3 and the external cylinder 4 flare from front to rear. However, each of the internal cylinder 3 and the external cylinder 4 may be in any shape, so long as the exhaust passage 21 formed between them expands from front to rear. For example, as shown in FIG. 4, the internal cylinder 3 may be straight except the second stepped portion 33. Alternatively, as shown in FIG. 5, the external cylinder 4 may be straight except the first stepped portion 43, and the internal cylinder 3 may narrow down from front to rear. Further alternatively, both the internal cylinder 3 and the external cylinder 4 may narrow down from front to rear.

### Embodiment 2

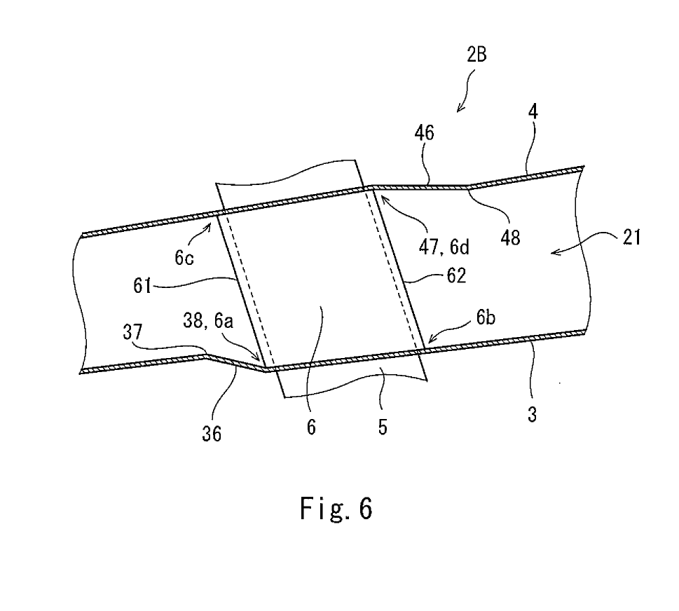

Next, an exhaust diffuser 2B according to Embodiment 2 of the present invention is described with reference to FIG. 6. In the present embodiment, the same components as those described in Embodiment 1 are denoted by the same reference signs as those used in Embodiment 1, and repeating the same descriptions is avoided below.

In the present embodiment, similar to Embodiment 1, both the internal cylinder 3 and the external cylinder 4 flare from front to rear. However, similar to the variations of Embodiment 1 described above, each of the internal cylinder 3 and the external cylinder 4 may be in any shape, so long as the exhaust passage 21 formed between them expands from front to rear.

In the present embodiment, the struts 5 coupling the bearing support 13 and the diffuser casing 17 together are inclined forward from the bearing support 13 toward the diffuser casing 17. In accordance therewith, each strut cover 6 is also inclined forward from the internal cylinder 3 toward the external cylinder 4.

The internal cylinder 3 includes a tapered first stepped portion 36, which is positioned such that the first stepped portion 36 overlaps the leading edge 61 of each strut cover 6 in the axial direction of the internal cylinder 3. The first stepped portion 36 reduces the diameter of the internal cylinder 3 over the entire circumference, such that reduction in the cross-sectional area of the exhaust passage 21 due to the strut covers 6, the reduction occurring from the upstream side to the downstream side of the leading edges 61 of the strut covers 6, is offset (but not necessarily reduced to zero).

In the present embodiment, the outer peripheral surface of the internal cylinder 3 has a straight sectional shape at the front of the first stepped portion 36, at the first stepped portion 36, and at the rear of the first stepped portion 36. Thus, the shape of the internal cylinder 3 is simple. The sectional shape of the inner peripheral surface of the internal cylinder 3 is described hereinafter in more detail. The inclination angle of the portion at the front of the first stepped portion 36 (i.e., the angle relative to the axial direction of the exhaust diffuser 2B) is equal to the inclination angle of the portion at the rear of the first stepped portion 36, and the inclination angle of the first stepped portion 36 is smaller than each of the inclination angles of the portions at the front and rear of the first stepped portion 36 (in some cases, the inclination angle of the first stepped portion 36 is a minus angle). It should be noted that the tapered first stepped portion 36 may be curved.

Meanwhile, the external cylinder 4 includes a tapered second stepped portion 46, which is positioned such that the second stepped portion 46 overlaps the trailing edge 62 of each strut cover 6 in the axial direction of the external cylinder 4. The second stepped portion 46 reduces the diameter of the external cylinder 4 over the entire circumference, such that increase in the cross-sectional area of the exhaust passage 21 due to the strut covers 6, the increase occurring from the upstream side to the downstream side of the trailing edges 62 of the strut covers 6, is offset (but not necessarily reduced to zero).

In the present embodiment, the inner peripheral surface of the external cylinder 4 has a straight sectional shape at the front of the second stepped portion 46, at the second stepped portion 46, and at the rear of the second stepped portion 46. Thus, the shape of the external cylinder 4 is simple. The sectional shape of the inner peripheral surface of the external cylinder 4 is described hereinafter in more detail. The inclination angle of the portion at the front of the second stepped portion 46 (i.e., the angle relative to the axial direction of the exhaust diffuser 2B) is equal to the inclination angle of the portion at the rear of the second stepped portion 46, and the inclination angle of the second stepped portion 46 is smaller than each of the inclination angles of the portions at the front and rear of the second stepped portion 46 (in some cases, the inclination angle of the second stepped portion 46 is a minus angle). It should be noted that the tapered second stepped portion 46 may be curved.

In the present embodiment, a front end 37 of the first stepped portion 36 is positioned forward of the upstream end 6c of each strut cover 6 on the external cylinder 4, and a rear end 48 of the second stepped portion 46 is positioned rearward of the downstream end 6b of each strut cover 6 on the internal cylinder 3. A rear end 38 of the first stepped portion 36 coincides with the upstream end 6a of each strut cover 6 on the internal cylinder 3, and a front end 47 of the second stepped portion 46 coincides with the downstream end 6d of each strut cover 6 on the external cylinder 4. This configuration makes it possible to readily weld each strut cover 6 to the internal cylinder 3 and the external cylinder 4. It should be noted that the rear end 38 of the first stepped portion 36 may be positioned forward of the upstream end 6a of each strut cover 6 on the internal cylinder 3.

As described above, in the exhaust diffuser 2B of the present embodiment, in the section from the first stepped portion 36 of the internal cylinder 3 to the second stepped portion 46 of the external cylinder 4, the distance from the internal cylinder 3 to the external cylinder 4 is partly increased. This makes it possible to reduce sudden changes in the cross-sectional area of the exhaust passage 21 due to the strut covers 6, the sudden changes occurring near the leading edges 61 and the trailing edges 62 of the strut covers 6. In addition, since it is unnecessary to form recesses in each of the internal cylinder 3 and the external cylinder 4, the internal cylinder 3 and the external cylinder 4 can be readily manufactured by sheet metal working.

Further, in the present embodiment, each strut cover 6 is inclined forward from the internal cylinder 3 toward the external cylinder 4. Accordingly, the first stepped portion 36 of the internal cylinder 3 is inclined in a manner similar to the leading edge 61 of each strut cover 6, and the second stepped portion 46 of the external cylinder 4 is inclined in a manner similar to the trailing edge 62 of each strut cover 6. This makes it possible to smoothly and continuously change the cross-sectional area of the exhaust passage 21.

Moreover, in the present embodiment, since the front end 37 of the first stepped portion 36 is positioned forward of the upstream end 6c of each strut cover 6 on the external cylinder 4, a detouring flow along the leading edge 61 of each strut cover 6 can be formed even near the upstream end 6c of each strut cover 6 on the external cylinder 4. Furthermore, since the rear end 48 of the second stepped portion 46 is positioned rearward of the downstream end 6b of each strut cover 6 on the internal cylinder 3, flow separation of the exhaust gas can be suppressed even near the downstream end 6b of each strut cover 6 on the internal cylinder 3.

### Other Embodiments

The present invention is not limited to the above-described embodiments. Various modifications can be made without departing from the spirit of the present invention.

For example, it is not essential that each of the exhaust diffusers 2A and 2B be incorporated in the gas turbine engine 1. For example, each of the exhaust diffusers 2A and 2B may be disposed downstream of a steam turbine. In this case, a structural body different from the diffuser casing may be disposed outside the external cylinder 4.

### REFERENCE SIGNS LIST

13 bearing support
17 diffuser casing (structural body)
2A, 2B exhaust diffuser
21 exhaust passage
3 internal cylinder
33 second stepped portion
34 front end
35 rear end
36 first stepped portion
37 front end
38 rear end
4 external cylinder
43 first stepped portion
44 front end
45 rear end
46 second stepped portion
47 front end
48 rear end
5 strut
6 strut cover
6a, 6c upstream end
6b, 6d downstream end
61 leading edge
62 trailing edge

1. An exhaust diffuser comprising:
an internal cylinder;
an external cylinder that forms an exhaust passage between the internal cylinder and the external cylinder, the exhaust passage expanding from front to rear;
a plurality of struts, each of which penetrates the internal cylinder and the external cylinder and couples a bearing support and a structural body together, the bearing support being disposed inside the internal cylinder, the structural body being disposed outside the external cylinder, each strut being inclined rearward from the bearing support toward the structural body; and
a plurality of strut covers that surround the plurality of struts, respectively, between the internal cylinder and the external cylinder, wherein
the external cylinder includes a tapered first stepped portion that expands a diameter of the external cylinder and that is positioned such that the first stepped portion overlaps leading edges of the plurality of strut covers in an axial direction of the external cylinder, and
the internal cylinder includes a tapered second stepped portion that expands a diameter of the internal cylinder and that is positioned such that the second stepped portion overlaps trailing edges of the plurality of strut covers in an axial direction of the internal cylinder.

2. The exhaust diffuser according to claim 1, wherein
a rear end of the first stepped portion coincides with upstream ends of the strut covers on the external cylinder, and
a front end of the second stepped portion coincides with downstream ends of the strut covers on the internal cylinder.

3. An exhaust diffuser comprising:
an internal cylinder;
an external cylinder that forms an exhaust passage between the internal cylinder and the external cylinder, the exhaust passage expanding from front to rear;
a plurality of struts, each of which penetrates the internal cylinder and the external cylinder and couples a bearing support and a structural body together, the bearing support being disposed inside the internal cylinder, the structural body being disposed outside the external cylinder, each strut being inclined forward from the bearing support toward the structural body; and
a plurality of strut covers that surround the plurality of struts, respectively, between the internal cylinder and the external cylinder, wherein
the internal cylinder includes a tapered first stepped portion that reduces a diameter of the internal cylinder and that is positioned such that the first stepped portion overlaps leading edges of the plurality of strut covers in an axial direction of the internal cylinder, and
the external cylinder includes a tapered second stepped portion that reduces a diameter of the external cylinder and that is positioned such that the second stepped portion overlaps trailing edges of the plurality of strut covers in an axial direction of the external cylinder.

4. The exhaust diffuser according to claim 3, wherein
a rear end of the first stepped portion coincides with upstream ends of the strut covers on the internal cylinder, and
a front end of the second stepped portion coincides with downstream ends of the strut covers on the external cylinder.
